(19) United States
(12) Patent Application Publication
(10) Pub. No.: US 2025/0317919 A1
(43) Pub. Date: Oct. 9, 2025

(54) BEAM MANAGEMENT

(71) Applicant: Nokia Technologies Oy, Espoo (FI)

(72) Inventors: Paolo BARACCA, Munich (DE); Dhanushka Nalin Jayaweera RAJAPAKSHALAGE, Oulu (FI); Keeth Saliya Jayasinghe LADDU, Espoo (FI); Kathiravetpillai SIVANESAN, Portland, OR (US); Samantha CAPORAL DEL BARRIO, Aalborg (DK)

(21) Appl. No.: 19/096,803

(22) Filed: Apr. 1, 2025

Related U.S. Application Data
(60) Provisional application No. 63/574,690, filed on Apr. 4, 2024.

(51) Int. Cl. H04W 72/044; H04W 24/10; H04W 72/542

(52) U.S. Cl. CPC H04W 72/046; H04W 24/10; H04W 72/542

(57) ABSTRACT

Embodiments of the present disclosure relate to beam management, for example, user equipment initiated beam management UEIBM. In an aspect, a terminal device receives from a network device a configuration for a filtering parameter for UEIBM. The terminal device determines an event for triggering the UEIBM based on the filtering parameter for the UEIBM. The terminal device transmits to the network device information of the UEIBM based on the event. In this way, the filtering parameter on the measurements can be determined for UEIBM, and the UEIBM can be performed based on the parameters, thereby improving the performance of communication with UEIBM.

### CROSS-REFERENCE TO RELATED APPLICATION

This application claims priority to, and the benefit of, U.S. Provisional Application No. 63/574,690, filed Apr. 4, 2024, the contents of which are hereby incorporated by reference in their entirety.

### FIELD

Various example embodiments relate to the field of communication and in particular, to methods, devices, apparatuses and a computer readable storage medium for beam management, for example, user equipment initiated beam management UEIBM.

### BACKGROUND

A communication network can be seen as a facility that enables communications between two or more communication devices, or provides communication devices access to a data network. A mobile or wireless communication network is one example of a communication network.

Such communication networks operate in accordance with standards, such as those promulgated by 3GPP (Third Generation Partnership Project) or ETSI (European Telecommunications Standards Institute). Examples of such standards include the so-called 5G (5th Generation) standard or other standards promulgated by 3GPP.

### SUMMARY

In general, example embodiments of the present disclosure provide a solution for beam management, especially for filtering operations for UEIBM. With this solution, the filtering parameter on the measurements can be determined for UEIBM, and the UEIBM can be performed based on the parameters, thereby improving the performance of communication with UEIBM.

In a first aspect, there is provided a terminal device. The terminal device comprises at least one processor and at least one memory storing instructions. The instructions, when executed by the at least one processor, cause the terminal device at least to receive from a network device a configuration for a filtering parameter for UEIBM. The terminal device is further caused to determine an event for triggering the UEIBM based on the filtering parameter for the UEIBM. The terminal device is further caused to transmit to the network device information of the UEIBM based on the event.

In a second aspect, there is provided a network device. The network device comprises at least one processor and at least one memory storing instructions. The instructions, when executed by the at least one processor, cause the network device at least to transmit to a terminal device a configuration for a filtering parameter for UEIBM. The network device is further caused to receive, from the terminal device information of the UEIBM based on the configuration. The network device is further caused to perform the UEIBM based on the information of the UEIBM.

In a third aspect, there is provided a method implemented at a terminal device. The method comprises receiving, from a network device a configuration for a filtering parameter for UEIBM. The method further comprises determining an event for triggering the UEIBM based on the filtering parameter for the UEIBM. The method further comprises transmitting, to the network device information of the UEIBM based on the event.

In a fourth aspect, there is provided a method implemented at a network device. The method comprises transmitting, to a terminal device a configuration for a filtering parameter for UEIBM. The method further comprises receiving from the terminal device information of the UEIBM based on the configuration. The method further comprises performing the UEIBM based on the information of the UEIBM.

In a fifth aspect, there is provided an apparatus. The apparatus comprises means for receiving, from a network device a configuration for a filtering parameter for UEIBM. The apparatus further comprises means for determining an event for triggering the UEIBM based on the filtering parameter for the UEIBM. The apparatus further comprises means for transmitting, to the network device information of the UEIBM based on the event.

In a sixth aspect, there is provided an apparatus. The apparatus comprises means for transmitting, to a terminal device a configuration for a filtering parameter for UEIBM. The apparatus further comprises means for receiving from the terminal device information of the UEIBM based on the configuration. The apparatus further comprises means for performing the UEIBM based on the information of the UEIBM.

In a seventh aspect, there is provided a non-transitory computer readable medium comprising program instructions for causing an apparatus to perform at least the method according to any one of the above third and fourth aspects.

In an eighth aspect, there is provided a computer program comprising instructions, which, when executed by an apparatus, cause the apparatus to perform at least the method according to any one of the above third and fourth aspects.

In a ninth aspect, there is provided a terminal device. The terminal device comprises receiving circuitry configured to receive, from a network device a configuration for a filtering parameter for UEIBM. The terminal device further comprises determining circuitry configured to determine an event for triggering the UEIBM based on the filtering parameter for the UEIBM. The terminal device further comprises transmitting circuitry configured to transmit, to the network device information of the UEIBM based on the event.

In a tenth aspect, there is provided a network device. The network device comprises transmitting circuitry configured to transmit, to a terminal device a configuration for a filtering parameter for UEIBM. The network device further comprises receiving circuitry configured to receive from the terminal device information of the UEIBM based on the configuration. The network device further comprises performing circuitry configured to perform the UEIBM based on the information of the UEIBM.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example communication network in which embodiments of the present disclosure may be implemented;

FIG. 2 illustrates a flowchart illustrating an example of process for filtering operations for UEIBM according to some embodiments of the present disclosure;

FIG. 3 illustrates a flowchart illustrating another example of process for filtering operations for UEIBM according to some embodiments of the present disclosure;

FIG. 4 illustrates a flowchart illustrating another example of process for filtering operations for UEIBM according to some embodiments of the present disclosure;

FIG. 5A illustrates an example of the entering and exiting conditions for the measurement events according to some embodiments of the present disclosure;

FIG. 5B illustrates another example of the entering and exiting conditions for the measurement events according to some embodiments of the present disclosure;

FIG. 5C illustrates a call flow illustrating an example for UEIBM according to some embodiments of the present disclosure;

FIG. 6 illustrates an example of the effect of filtering operation for UEIBM according to some embodiments of the present disclosure;

FIGS. 7A and 7B illustrates the examples of the impact on the final throughput of filtering for UEIBM according to some other embodiments of the present disclosure;

FIG. 8 illustrates a flowchart of a method implemented at a terminal device according to some other embodiments of the present disclosure;

FIG. 9 illustrates a flowchart of a method implemented at a network device according to some other embodiments of the present disclosure

FIG. 10 illustrates a simplified block diagram of an apparatus that is suitable for implementing embodiments of the present disclosure; and

FIG. 11 illustrates a block diagram of an example computer readable medium in accordance with some embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) and the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” and “access network device” refer to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a transmission reception point (TRP), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In the scope of 3GPP Rel-19, some use cases where UE could benefit from initiating the beam reporting and/or switch are being identified. The UE-initiated transmission configuration indication TCI state/beam reporting/switch feature refers to the case where the UE may be configured with at least one event/condition. For example, the event/condition may be the quality of the current beam is worse than a certain threshold (Event-1), the quality of at least one new beam, such as L1-RSRP, becomes a threshold value better than the current beam (Event-2), the quality of a new beam is better than a certain threshold (Event-3), or the quality of the current beam is worse than a threshold 1, and quality of at least one new beam is better than a threshold 2 (Event-4), and so on. And then the UE may start TCI-state/beam reporting/switch if this at least one event/condition occurs or is satisfied. In 3GPP this procedure is also referred as UE-initiated beam management UEIBM.

However, independently of the specific events, it has been recognized that filtering operation on the metric that is used to trigger the report, such as reference signal received power RSRP, may need careful design because no filtering, although it allows to quickly report to the network up-to-date information, it may also cause some performance loss by generating too many reports with potential ping-pong effects.

According to some embodiments of the present disclosure, there is provided a solution for beam management, especially for filtering operations for UEIBM. Principles and embodiments of the present disclosure will be described in detail below with reference to the accompanying drawings.

FIG. 1 illustrates a schematic diagram of an example communication network 100 in which some embodiments of the present disclosure can be implemented. As shown in FIG. 1, the communication network 100 may include terminal device 110, a network device 120.

It is to be understood that the number of network devices and terminal devices is only for the purpose of illustration without suggesting any limitations. The system 100 may include any suitable number of network devices and terminal devices adapted for implementing embodiments of the present disclosure.

Communications in the communication system 100 may be implemented according to any proper communication protocol(s), comprising, but not limited to, cellular communication protocols of the first generation (1G), the second generation (2G), the third generation (3G), the fourth generation (4G), the fifth generation (5G) and the sixth generation (6G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

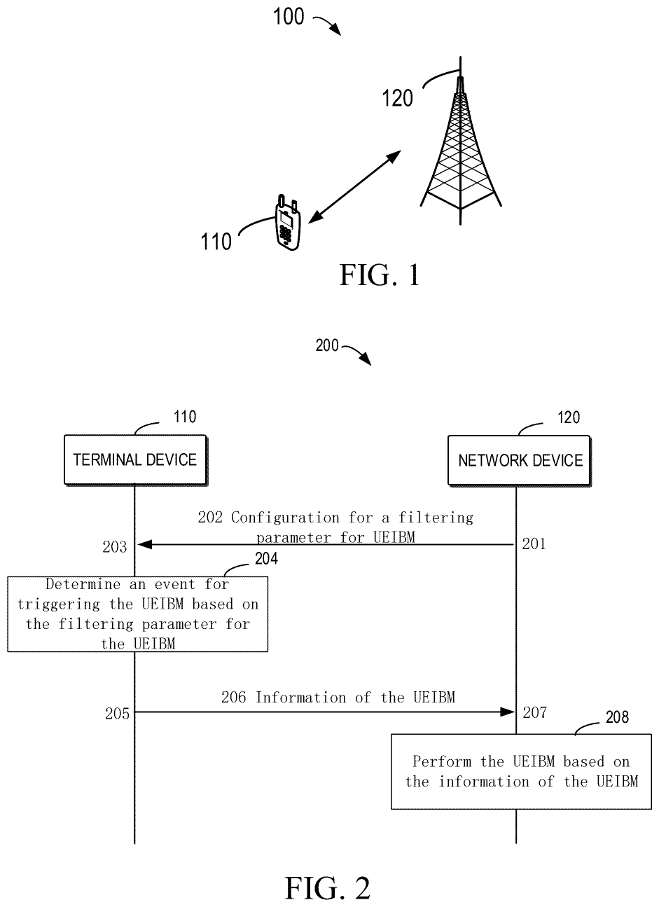

FIG. 2 illustrates a flowchart illustrating an example of process for filtering operations for UEIBM according to some embodiments of the present disclosure. For the purpose of discussion, the process 200 will be described with reference to FIG. 1. The process 200 may involve the terminal device 110, the network device 120 as illustrated in FIG. 1. It would be appreciated that although the process 200 for link has been described in the communication system 100 of FIG. 1, this process may be likewise applied to other communication scenarios where different network devices are jointly deployed to provide respective serving cells.

In some embodiments, the network device 120 transmits to the terminal device 110 a configuration for a filtering parameter for UEIBM. And the terminal device 110 receives from the network device 120 the configuration for the filtering parameter for UEIBM. Specifically, as shown in FIG. 2, the network device 120 transmits 201 to the terminal device 110 a configuration for a filtering parameter for UEIBM. And the terminal device 110 receives 203 the configuration for the filtering parameter for UEIBM.

In some embodiments, the terminal device 110 determines an event for triggering the UEIBM based on the filtering parameter for the UEIBM. Specifically, as shown in FIG. 2, the terminal device determines 204 an event for triggering the UEIBM based on the filtering parameter for the UEIBM.

In some embodiments, the terminal device 110 transmits the information of the UEIBM based on the event. Specifically, as shown in FIG. 2, the terminal device 110 transmits 205 the information of the UEIBM 206 to the network device 120.

In some embodiments, the network device 120 performs the UEIBM based on the information of the UEIBM. Specifically, as shown in FIG. 2, the network device 120 performs 208 the UEIBM based on the information of the UEIBM.

With the solution of the process, the filtering parameter on the measurements can be determined for UEIBM, and the UEIBM can be performed based on the parameters, thereby improving the performance of communication with UEIBM.

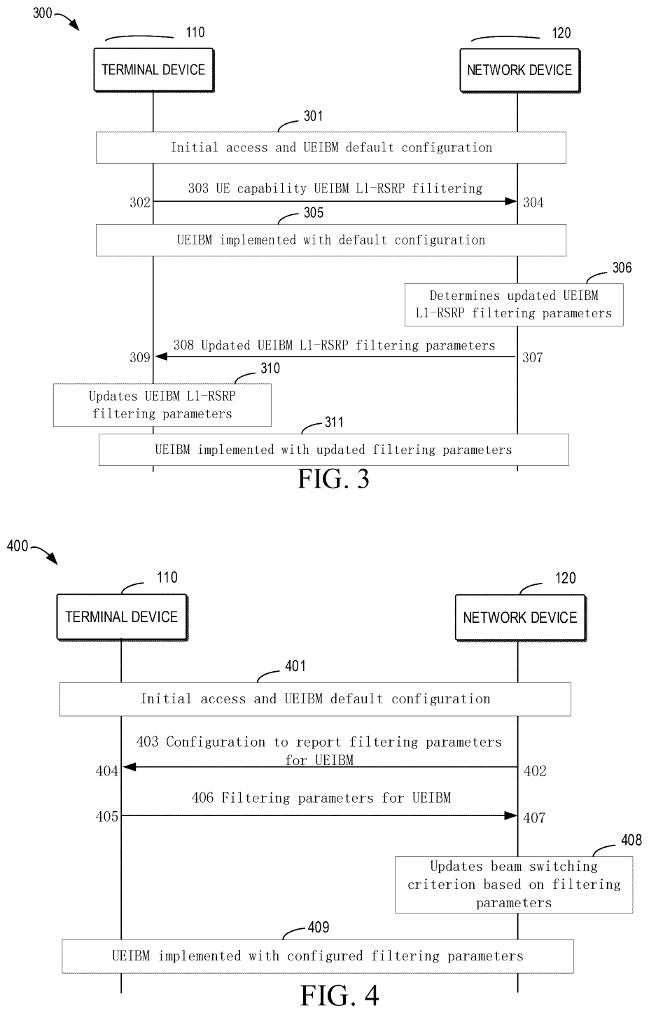

FIG. 3 illustrates a flowchart illustrating another example of process for filtering operations for UEIBM according to some embodiments of the present disclosure. In FIG. 3, there is detailed signaling workflow to support above-mentioned solution. For the purpose of discussion, the process 300 will be described with reference to FIG. 1. The process 300 may involve the terminal device 110, the network device 120 as illustrated in FIG. 1. It would be appreciated that although the process 300 has been described in the communication system 100 of FIG. 1, this process may be likewise applied to other communication scenarios where different network devices are jointly deployed to provide respective serving cells.

In some embodiments, as shown in FIG. 3, the initial access and UEIBM default configuration 301 is performed. Specifically, the terminal device 110 performs initial access to access to the cell of network device 120. And for the beam management, there is only the default configuration of UEIBM just after the initial access.

In some embodiments, the network device 120 configures the filtering parameter for the terminal device. And the filtering parameter is a number of measurement instances for the UEIBM, or a time window for determining a number of measurement instances for the UEIBM. The measurement instances are for reference signal received power RSRP, reference signal received quality RSRQ, a received signal strength indicator RSSI, or a signal to interference plus noise ratio SINR. For example, the number of L1-RSRP measurement instances (X) implicitly controls the terminal device's L1-RSRP filtering (e.g., an average over a certain time window or an auto regressive moving-average ARMA filtering that contains the number of measurement instances shall be considered by the terminal device 110). The network device configures or activates (indicates) a number of L1-RSRP measurement instances (X) used for UEIBM. Alternatively or additionally, the network device 120 configures a time window to control the number of L1-RSRP measurement instances.

In some embodiments, the terminal device 110 transmits a number of supported measurement instances for the UEIBM or a supported length of the time window. For example, as shown in FIG. 3, the terminal device 110 transmits 302 the UE capability for UEIBM L1-RSRP filtering 303 to the network device 120. And the network device 120 receives 304 the UE capability UEIBM for UEIBM L1-RSRP filtering 303. The UE capability UEIBM for UEIBM L1-RSRP filtering 303 comprises the number of supported L1-RSRP measurement instances for the UEIBM or a supported length of the time window for L1-RSRP measurement, that is, the supported number of measurement instances X and/or supported time window for the measurement averaging. In other words, the UE capability is defined for either the supported X or the supported length of such time window, i.e., for example in the form of a minimum/maximum time window possible for measurements at that UE.

In some embodiments, as shown in FIG. 3, the UEIBM is implemented 305 with default configuration. Specifically, since the dynamic filtering parameters has not been determined by the network device 120, the UEIBM has to be implemented with default configuration.

In some embodiments, as shown in FIG. 3, the network device 120 determines 306 the updated UEIBM L1-RSRP filtering parameters. For example, the network device 120 determines updated L1-RSRP filtering parameters based on the number of reported events or on the UE speed, in terms of number of measurement instances X and/or time window for the measurement averaging.

In some embodiments, the network device transmits a configuration for a filtering parameter for the UEIBM. And the configuration comprises a value of the filtering parameter for the UEIBM. Specifically, as shown in FIG. 3, the network device 120 transmits 307 the updated UEIBM L1-RSRP filtering parameters to the terminal device 110. And the terminal device 110 receives 309 the updated UEIBM L1-RSRP filtering parameters. In some embodiment, the configuration is transmitted in a radio resource control RRC message or a media access control-control element MAC-CE. For example, the number of L1-RSRP measurement instances used for UEIBM is RRC configured by extending the timeRestrictionForChannelMeasurements higher layer parameter. And the timeRestrictionForChannelMeasurements higher layer parameter may configure values (e.g., X=1, 2, 4, 8, 12, 16) as the parameter configuration values. For another example, the number of L1-RSRP measurement instances for UEIBM is dynamically indicated in the form of a MAC-CE information element. The MAC-CE comprises information element for number of measurement instances (e.g., X=1, 2, 4, 8, 12, 16) or time window (e.g., as timeWindowUEIBM).

In some embodiments, the time window is determined by a number of events reported by the terminal device, an estimated terminal device speed, a number of events reported by all served terminal devices, or a number of active terminal devices in a cell. Specifically, such timeWindowUEIBM can be updated in a very dynamic way and fast way depending on channel and load conditions. For example, the network device 120 can decide based on its own implementation if to activate this filtering/averaging. Some conditions at the network device 120 side are number of events reported by that terminal device 110 over a certain time window is above a threshold for larger timeWindowUEIBM, or estimated terminal device 110 speed is above a certain threshold for smaller timeWindowUEIBM, or number of events reported by all the served terminal devices over a certain time window is above a threshold for larger timeWindowUEIBM, or number of active terminal devices in the cell is above a certain threshold (more conservative solution) for larger timeWindowUEIBM.

In some embodiments, as shown in FIG. 3, the terminal device updates 310 the UEIBM L1-RSRP filtering parameters. Specifically, the terminal device 110 applies those L1-RSRP filtering parameters.

In some embodiments, the UEIBM is implemented 311 with updated filtering parameters. For example, the UEIBM continues running with those updated L1-RSRP filtering parameters. The terminal device 110 shall consider the configured or indicated number for measurements to determine the event that triggers UEIBM. In other words, the terminal device 110 reports beam related information based on an event, where the event (e.g., Event-2) is triggered only based on latest X measurement instances of beams within a resource set.

FIG. 4 illustrates a flowchart illustrating another example of process for filtering operations for UEIBM according to some embodiments of the present disclosure. In FIG. 4, there is detailed signaling workflow to support above-mentioned solution. For the purpose of discussion, the process 400 will be described with reference to FIG. 1. The process 400 may involve the terminal device 110, the network device 120 as illustrated in FIG. 1. It would be appreciated that although the process 400 has been described in the communication system 100 of FIG. 1, this process may be likewise applied to other communication scenarios where different network devices are jointly deployed to provide respective serving cells.

In some embodiments, as shown in FIG. 4, the initial access and UEIBM default configuration 401 is performed. Specifically, the terminal device 110 perform initial access to access to the cell of network device 120. And for the beam management, there is only the default configuration of UEIBM just after the initial access.

In some embodiments, the network device 120 transmits to a terminal device 110 a configuration for a filtering parameter for UEIBM. And the configuration indicates to the terminal device 110 to report a value of the filtering parameter for the UEIBM. Specifically, as shown in FIG. 4, the network device 120 transmits 402 the configuration to report filtering parameters for UEIBM 403. And the terminal device 110 receives 404 the configuration to report filtering parameters for UEIBM 403. Specifically, the network device 120 configures the terminal device 110 to report a filtering parameter for UEIBM, e.g., the number of measurement instances X and/or the time window for the measurement averaging. For example, the network device 120 can configure the terminal device 110 to report an event-related measurement parameter considered by the terminal device 110 for UEIBM. And the even-related measurement parameter may be carried in the UEIBM report and it is providing information on terminal device's L1-RSRP filtering. The event-related measurement parameter can be the number L1-RSRP measurement instances considered by the terminal device 110 when triggering the event. Parameter values can be defined as X=1, 2, 4, 8, 12, 16, where X is reported with the UEIBM. For another example, the event-related measurement parameter can be the time window that is considered by the terminal device when triggering the event. Parameter values can be defined as Y=100 ms, 200 ms, etc., where Y is reported with the UEIBM.

In some embodiments, as shown in FIG. 4, the terminal device 110 transmits 405 the filtering parameters for UEIBM. And the network device 120 receives 407 the filtering parameters for UEIBM. Specifically, the terminal device 110 reports such filtering parameter for UEIBM.

In some embodiments, the network device 110 performs the UEIBM based on the filtering parameter. Specifically, as shown in FIG. 4, the network device updates 408 the beam switching criterion based on the filtering parameters. And the UEIBM is implemented 409 with configured filtering parameters. Specifically, the network device 120 considers such filtering parameter for beam switching decisions, e.g., if the reported even-related measurement parameter is small (where not much filtering considered), the network device 120 may further wait for additional reports to avoid ping-pong effect in beam switching. The UEIBM continues running with the configured L1-RSRP filtering parameter. For example, based on the UEIBM report, the network device 120 may consider/decide switching the current beam to a reported best beam. And some additional considerations may also be considered by the network device 120. If the reported even-related measurement parameter is small (where not much filtering is considered), the network device 120 may further wait for additional reports to avoid ping-pong effect in beam switching. If the reported event-related measurement parameter is large enough (where long filtering is considered), the network device 120 may decide to change the current beam based on the reported best beam. And the network device 120 can consider any other considerations for the beam switching.

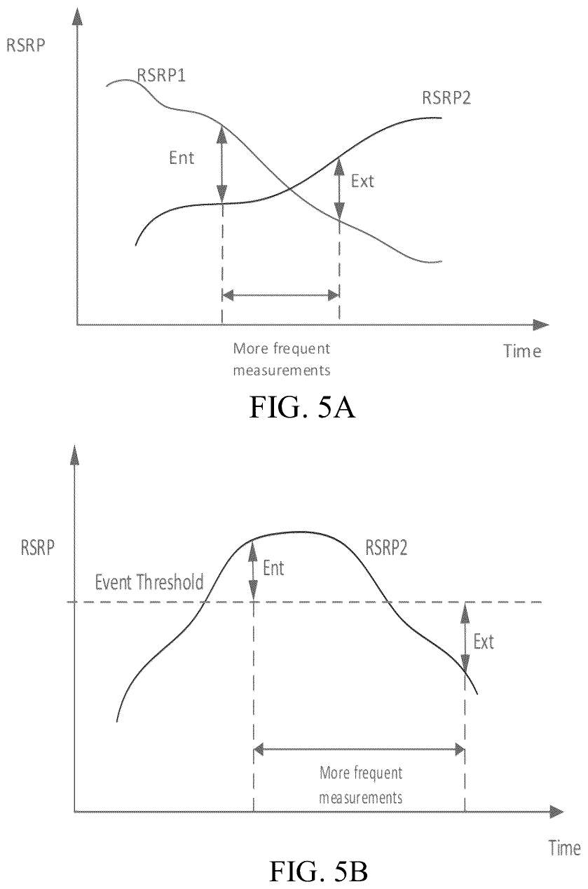

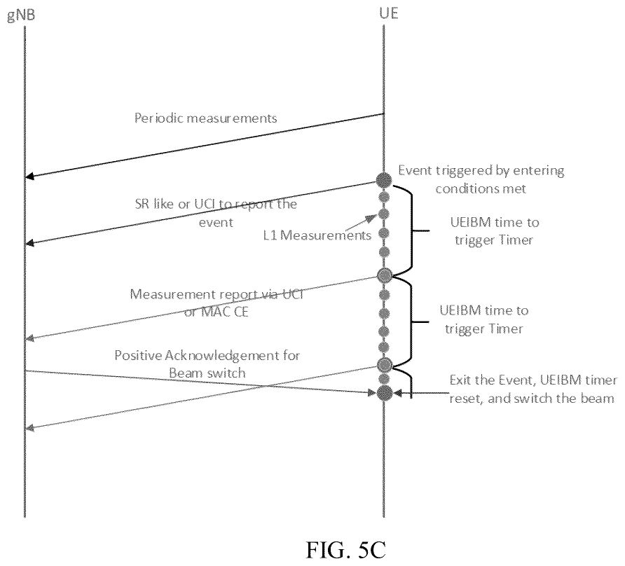

FIG. 5A illustrates an example of the entering and exiting conditions for the measurement events according to some embodiments of the present disclosure. For the purpose of discussion, FIG. 5A will be described with reference to FIG. 1. FIG. 5A may involve the terminal device 110, the network device 120 as illustrated in FIG. 1. It would be appreciated that although the FIG. 5A has been described in the communication system 100 of FIG. 1, it may be likewise applied to other communication scenarios where different network devices are jointly deployed to provide respective serving cells.

In some embodiments, an entering condition and an exiting condition for a measurement event for the UEIBM is determined. And the entering condition and the exiting condition are predefined or configured by the network device 120. Specifically, the terminal device 110 can be defined by spec or configured via NW to consider entering and exiting conditions for the measurement events considered by the UE for UEIBM. And the entering and exiting conditions keep the ping pongs, measurement overhead, and signalling overhead low.

In some embodiments, the entering condition and the exiting condition are based on a first L1-RSRP of a serving beam and a second L1-RSRP of a target beam. Specifically, as shown in FIG. 5A, the entering condition and exiting condition may be defined with respect to the L1-RSRP of the current beam. And the entering condition may be defined as entering threshold (in dB) and exiting condition may be defined as exiting threshold (in dB).

As shown in FIG. 5A, suppose RSRP1 and RSRP2 are the measurements from beams 1 and 2, respectively. The terminal device 110 is currently served by beam 1 and wants to move to beam 2. Here, “Ent” and “Ext” are the thresholds for entering and exiting the event.

In some embodiments, the entering condition comprises that the first L1-RSRP is smaller than the second L1-RSRP plus a first threshold, and the exiting condition comprises that the second L1-RSRP is greater than the first L1-RSRP plus a second threshold. Specifically, as shown in FIG. 5A, the entering condition of the measurement event is RSRP1<RSRP2+Ent. The exiting condition of the measurement event is RSRP1+Ext<RSRP2. During the event triggered period, as shown in FIG. 5A, more frequent measurements are made.

FIG. 5B illustrates another example of the entering and exiting conditions for the measurement events according to some embodiments of the present disclosure. For the purpose of discussion, FIG. 5B will be described with reference to FIG. 1. FIG. 5B may involve the terminal device 110, the network device 120 as illustrated in FIG. 1. It would be appreciated that although the FIG. 5B has been described in the communication system 100 of FIG. 1, it may be likewise applied to other communication scenarios where different network devices are jointly deployed to provide respective serving cells.

In some embodiments, the entering condition and the exiting condition are based on an event threshold. Specifically, as shown in FIG. 5B, the entering condition and exiting condition may be defined with respect to an event threshold, where entering condition may be defined as entering threshold (in dB) and exiting condition may be defined as exiting threshold (in dB). The entering condition of the measurement event is Threshold+Ent<RSRP2 and the exiting condition of the measurement event is Threshold>RSRP2+Ext.

Refer to FIG. 5C, which illustrates a call flow illustrating an example for UEIBM. In some embodiments, as shown in FIG. 5C, as soon as the entering condition is satisfied, the terminal device 110 indicates that to network device 120 by uplink control signalling (SR like message or other UCI). The frequent measurements are filtered using windowing or ARMA type filters. The terminal device 110 runs a timer called “UEIBM Time to trigger”. And when the timer expires, the terminal device 110 send the measurement report to the network device 120.

In some embodiments, as shown in FIG. 5C, after “UEIBM Time to trigger” timer resets itself, the averaging and reporting process continues until the acknowledgment/response (direct or indirect) from the network device 120 received regarding the beam switching or conditions for the beam failure conditions are reached with beam 1 or the event exit condition is met. The direct acknowledgment/response is carried to the terminal device 110 by the DCI or MAC CE. The indirect acknowledgment includes resource allocations on beam 2. If the beam failure conditions are reached with beam 1, terminal device 110 will start the RACH procedure.

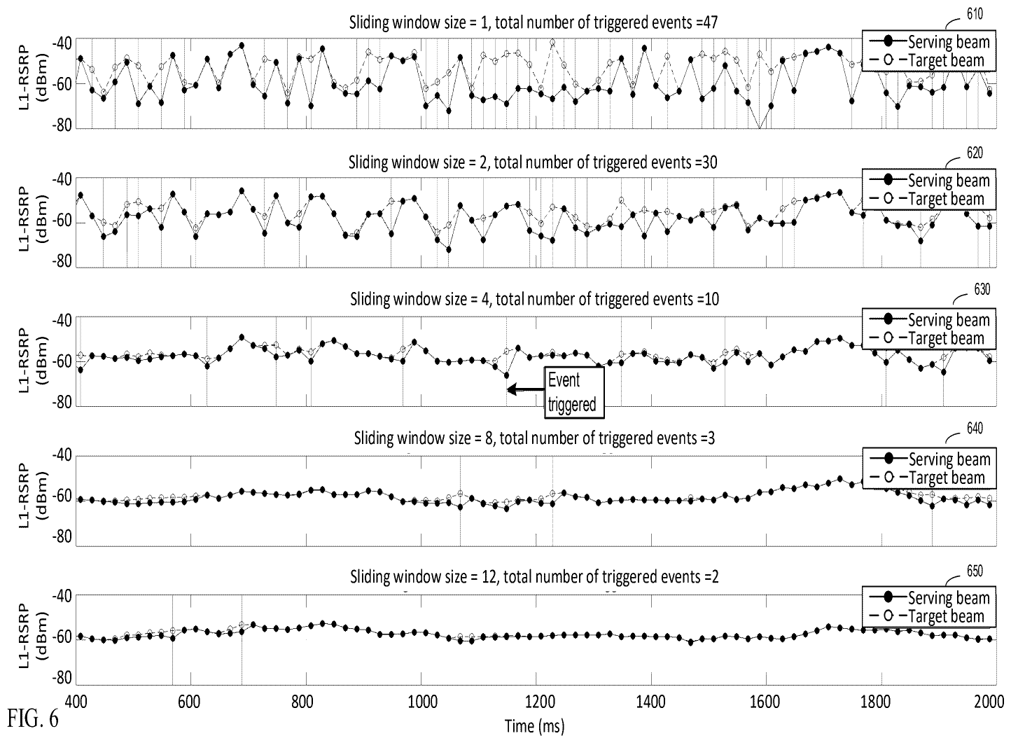

FIG. 6 illustrates an example of the effect of filtering operation for UEIBM according to some embodiments of the present disclosure. Specifically, the effect of filtered L1-RSRP for event triggering is depicted in FIG. 6 for a terminal device configured with Event-2 with a threshold of 3 dB. As shown in FIG. 6, different filtering options are considered for a terminal device by varying measurement averaging duration (or sliding window size). The solid dots represent the serving beam L1-RSRP values. The hollow dots represent the target beam's L1-RSRP values if there is a better beam with respect to the serving beam. If Event-2 triggers (target beam is 3 dB better than the serving beam), beam switch happens, and a hollow dot turn to a solid dot for the next measurement event.

According to these results, if filtering is not applied, i.e., sliding window size=1 as shown at 610, the advantage is that there is very fast feedback to the network if new target beam emerges. And the disadvantage is a large number of multiple reports are generated, e.g., 47 events in about 2 s simulation time, leading to beam ping-pong effect and potential large fluctuation of the L1-RSRP of the serving beam, which may as well be source of potential packet errors.

On the other side, as shown in FIG. 6, if filtering is applied as shown at 620, 630, 640, and 650, there is longer delay in the feedback to the network if new target beam emerges. And there is less beam reporting overhead, and an event is triggered if the target beam is a stable beam (e.g., with sliding window size=8, we observe just 3 events in about 2 s simulation time, and a rather stable L1-RSRP around −60/−50 dBm).

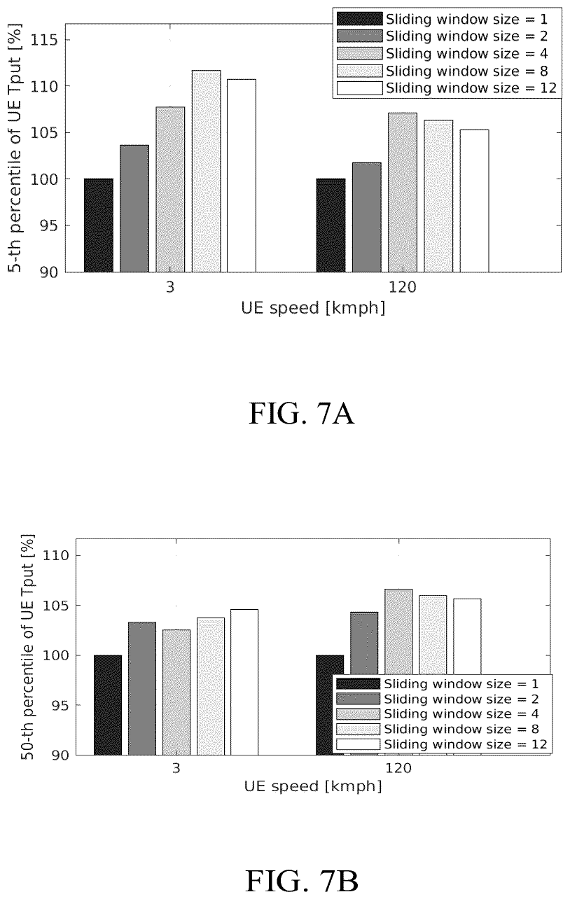

FIGS. 7A and 7B illustrate the examples of the impact on the final throughput of filtering for UEIBM according to some embodiments of the present disclosure. Besides the number of events shown in FIG. 6, the impact on the final throughput of filtering is shown in FIG. 7A and FIG. 7B, which plot the 5th and 50th percentile of the UE throughput, respectively, for different sliding window size and UE speed. The results show that filtering is beneficial in improving the throughput performance. But the optimal filtering, in this case in the form of just the sliding window size, may vary depending on terminal device speed and terminal location, i.e., how good the terminal device-network device channel is. For example, cell-edge terminal devices with low speeds may use moderate sliding window (SW) size for example 8, or cell-edge terminal devices with higher speeds may need to reduce the SW size to 4 to mitigate the effect of delayed response. Cell-median terminal devices with low speeds may use longer sliding window (SW) size for example 12, as the L1-RSRP degradation is not severe when compared to cell-edge UEs. Cell-median terminal devices with higher speeds may use SW size such as 4.

Note also that UEIBM is not a resource-consuming procedure such as handover, and therefore there may be scenarios where it is ok that the UE reports many events, e.g. if that terminal device is the only one active in the cell, because still all those events may provide each a little bit of gain for that terminal device.

In view of the above description of the various embodiments of the present disclosure, these embodiments of the present disclosure provide the advantage of a dynamic adaptation for the filtering parameter on the measurements for UEIBM. The filtering parameters can be configured by the network device. Alternatively, the UE can determine the filtering parameter for UEIBM. Then the performance of communication with UEIBM is improved.

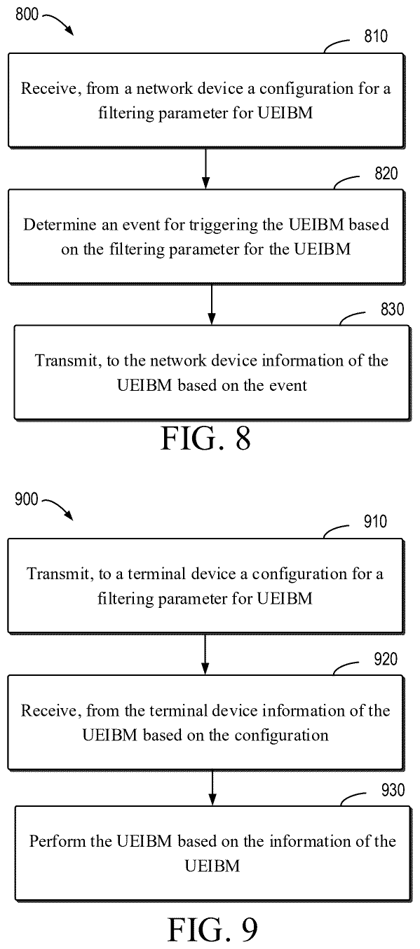

FIG. 8 shows a flowchart of an example method 800 implemented at a terminal device in accordance with some embodiments of the present disclosure. For the purpose of discussion, the method 800 will be described from the perspective of the terminal device 110 with reference to FIG. 1.

At block 810, the terminal device 110 receives from the network device 120 a configuration for a filtering parameter for user equipment initiated beam management (UEIBM). At block 820, the terminal device 110 determines an event for triggering the UEIBM based on the filtering parameter for the UEIBM. At block 830, the terminal device 110 transmits to the network device 120 information of the UEIBM based on the event.

In some embodiments, the filtering parameter is a number of measurement instances for the UEIBM. In some embodiments, the filtering parameter is a time window for determining a number of measurement instances for the UEIBM. In some embodiments, the measurement instances are for one or more of RSRP, RSRQ, a RSSI, or a SINR. In some embodiments, the configuration comprises a value of the filtering parameter for the UEIBM.

In some embodiments, the configuration is transmitted in a RRC message or a MAC-CE. In some embodiments, the terminal device 110 transmits a number of supported measurement instances for the UEIBM. In some embodiments, the terminal device 110 transmits a supported length of the time window. In some embodiments, the configuration indicates to the terminal device 110 to report a value of the filtering parameter for the UEIBM.

In some embodiments, the value of the filtering parameter is transmitted in a report for the UEIBM. In some embodiments, the terminal device 110 determines an entering condition and an exiting condition for a measurement event for the UEIBM. In some embodiments, the entering condition and the exiting condition are based on a first L1-RSRP of a serving beam and a second L1-RSRP of a target beam.

In some embodiments, the entering condition comprises that the first L1-RSRP is smaller than the second L1-RSRP plus a first threshold, and the exiting condition comprises that the second L1-RSRP is greater than the first L1-RSRP plus a second threshold. In some embodiments, the entering condition and the exiting condition are based on an event threshold. In some embodiments, the entering condition and the exiting condition are predefined or configured by a network device.

FIG. 9 shows a flowchart of an example method 900 implemented at a network device in accordance with some embodiments of the present disclosure. For the purpose of discussion, the method 900 will be described from the perspective of the network device 120 with reference to FIG. 1.

At block 910, the network device 120 transmits to the terminal device 110 a configuration for a filtering parameter for user equipment initiated beam management (UEIBM). At block 920, the network device receives from the terminal device 110 information of the UEIBM based on the configuration. At block 930, the network device 120 performs the UEIBM based on the information of the UEIBM.

In some embodiments, the filtering parameter is a number of measurement instances for the UEIBM. In some embodiments, the filtering parameter is a time window for determining a number of measurement instances for the UEIBM. In some embodiments, the measurement instances are for one or more of RSRP, RSRQ, a RSSI, or a SINR. In some embodiments, the configuration comprises a value of the filtering parameter for the UEIBM.

In some embodiments, the configuration is transmitted in a RRC message or a MAC-CE. In some embodiments, the time window is determined by one or more of a number of events reported by the terminal device, an estimated terminal device speed, a number of events reported by all served terminal devices, or a number of active terminal devices in a cell. In some embodiments, the network device 120 receives a number of supported measurement instances for the UEIBM.

In some embodiments, the network device receives a supported length of the time window for the terminal device. In some embodiments, the configuration indicates to the terminal device to report a value of the filtering parameter for the UEIBM. In some embodiments, the value of the filtering parameter is received in a report for the UEIBM.

In some embodiments, the network device 120 determines an entering condition and exiting condition for a measurement event for the UEIBM. In some embodiments, the entering condition and exiting condition are based on a first L1-RSRP of a serving beam and a second L1-RSRP of a target beam.

In some embodiments, the entering condition comprises that the first L1-RSRP is smaller than the second L1-RSRP plus a first threshold, and the exiting condition comprises that the second L1-RSRP is greater than the first L1-RSRP plus a second threshold. In some embodiments, the entering condition and the exiting condition are based on an event threshold. In some embodiments, the entering condition and exiting condition are predefined or configured by the network device.

In some embodiments, an apparatus capable of performing any of the method 800 (for example, the terminal device 110) may comprise means for performing the respective steps of the method 800. The means may be implemented in any suitable form. For example, the means may be implemented in a circuitry or software module.

In some embodiments, the apparatus comprises means for receiving from the network device 120 a configuration for a filtering parameter for user equipment initiated beam management (UEIBM). The apparatus comprises means for determining an event for triggering the UEIBM based on the filtering parameter for the UEIBM. The apparatus comprises means for transmitting to the network device 120 information of the UEIBM based on the event.

In some embodiments, the filtering parameter is a number of measurement instances for the UEIBM. In some embodiments, the filtering parameter is a time window for determining a number of measurement instances for the UEIBM. In some embodiments, the measurement instances are for one or more of RSRP, RSRQ, a RSSI, or a SINR. In some embodiments, the configuration comprises a value of the filtering parameter for the UEIBM.

In some embodiments, the configuration is transmitted in a RRC message or a MAC-CE. In some embodiments, the apparatus comprises means for transmitting a number of supported measurement instances for the UEIBM. In some embodiments, the apparatus comprises means for transmitting a supported length of the time window. In some embodiments, the configuration indicates to the terminal device 110 to report a value of the filtering parameter for the UEIBM.

In some embodiments, the value of the filtering parameter is transmitted in a report for the UEIBM. In some embodiments, the apparatus comprises means for determining an entering condition and an exiting condition for a measurement event for the UEIBM. In some embodiments, the entering condition and the exiting condition are based on a first L1-RSRP of a serving beam and a second L1-RSRP of a target beam.

In some embodiments, the entering condition comprises that the first L1-RSRP is smaller than the second L1-RSRP plus a first threshold, and the exiting condition comprises that the second L1-RSRP is greater than the first L1-RSRP plus a second threshold. In some embodiments, the entering condition and the exiting condition are based on an event threshold. In some embodiments, the entering condition and the exiting condition are predefined or configured by a network device.

In some embodiments, an apparatus capable of performing any of the method 900 (for example, the network device 120) may comprise means for performing the respective steps of the method 900. The means may be implemented in any suitable form. For example, the means may be implemented in a circuitry or software module.

In some embodiments, the apparatus comprises means for transmitting to the terminal device 110 a configuration for a filtering parameter for user equipment initiated beam management (UEIBM). The apparatus comprises means for receiving from the terminal device 110 information of the UEIBM based on the configuration. The apparatus comprises means for performing the UEIBM based on the information of the UEIBM.

In some embodiments, the filtering parameter is a number of measurement instances for the UEIBM. In some embodiments, the filtering parameter is a time window for determining a number of measurement instances for the UEIBM. In some embodiments, the measurement instances are for one or more of RSRP, RSRQ, a RSSI, or a SINR. In some embodiments, the configuration comprises a value of the filtering parameter for the UEIBM.

In some embodiments, the configuration is transmitted in a RRC message or a MAC-CE. In some embodiments, the time window is determined by one or more of a number of events reported by the terminal device, an estimated terminal device speed, a number of events reported by all served terminal devices, or a number of active terminal devices in a cell. In some embodiments, the apparatus comprises means for receiving a number of supported measurement instances for the UEIBM.

In some embodiments, the apparatus comprises means for receiving a supported length of the time window for the terminal device. In some embodiments, the configuration indicates to the terminal device to report a value of the filtering parameter for the UEIBM. In some embodiments, the value of the filtering parameter is received in a report for the UEIBM.

In some embodiments, the apparatus comprises means for determining an entering condition and exiting condition for a measurement event for the UEIBM. In some embodiments, the entering condition and exiting condition are based on a first L1-RSRP of a serving beam and a second L1-RSRP of a target beam.

In some embodiments, the entering condition comprises that the first L1-RSRP is smaller than the second L1-RSRP plus a first threshold, and the exiting condition comprises that the second L1-RSRP is greater than the first L1-RSRP plus a second threshold. In some embodiments, the entering condition and the exiting condition are based on an event threshold. In some embodiments, the entering condition and exiting condition are predefined or configured by the network device.

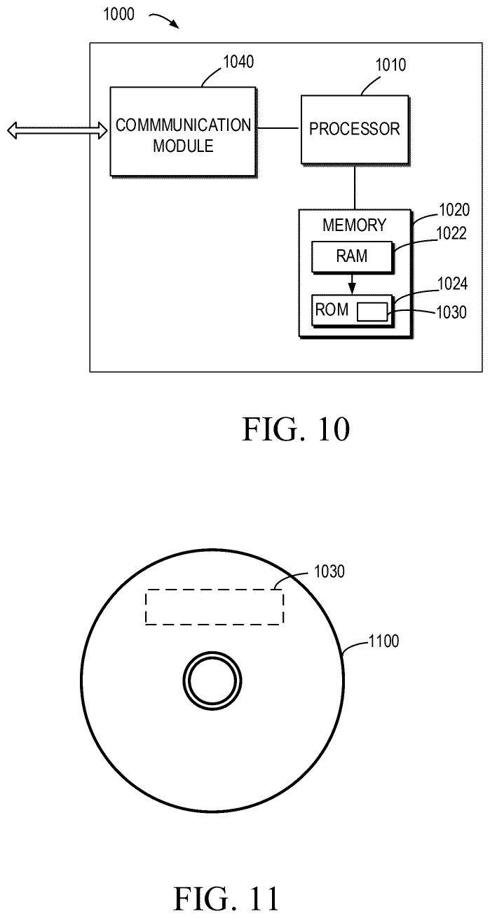

FIG. 10 is a simplified block diagram of a device 1000 that is suitable for implementing embodiments of the present disclosure. The device 1000 may be provided to implement the communication device, for example the terminal device 110, the network device 120 as shown in FIG. 1. As shown, the device 1000 includes one or more processors 1010, one or more memories 1020 coupled to the processor 1010, and one or more communication modules 1040 coupled to the processor 1010.

The communication module 1040 is for bidirectional communications. The communication module 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program 1030 so that the device 1000 may perform any process of the disclosure as discussed with reference to FIGS. 2 to 9. The embodiments of the present disclosure may also be implemented by hardware or by a combination of software and hardware.

In some embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 800-900 as described above with reference to FIGS. 8-9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device comprising:
at least one processor; and
at least one memory storing instructions that, when executed by the at least one processor, cause the terminal device at least to:
receive, from a network device a configuration for a filtering parameter for user equipment initiated beam management (UEIBM);
determine an event for triggering the UEIBM based on the filtering parameter for the UEIBM; and
transmit, to the network device information of the UEIBM based on the event.

2. The terminal device of claim 1, wherein the filtering parameter is a number of measurement instances for the UEIBM.

3. The terminal device of claim 2, wherein the measurement instances are for one or more of the following:
reference signal received power (RSRP);
reference signal received quality (RSRQ);
a received signal strength indicator (RSSI); or
a signal to interference plus noise ratio (SINR).

4. The terminal device of claim 2, wherein the terminal device is further caused to:
transmit a number of supported measurement instances for the UEIBM.

5. The terminal device of claim 1, wherein the filtering parameter is a time window for determining a number of measurement instances for the UEIBM.

6. The terminal device of claim 5, wherein the terminal device is further caused to:
transmit a supported length of the time window.

7. The terminal device of claim 1, wherein the configuration comprises a value of the filtering parameter for the UEIBM.

8. The terminal device of claim 1, wherein the configuration is transmitted in a radio resource control (RRC) message or a media access control-control element (MAC-CE).

9. The terminal device of claim 1, wherein the configuration indicates to the terminal device to report a value of the filtering parameter for the UEIBM.

10. The terminal device of claim 9, wherein the value of the filtering parameter is transmitted in a report for the UEIBM.

11. The terminal device of claim 1, wherein the terminal device is further caused to:
determine an entering condition and an exiting condition for a measurement event for the UEIBM.

12. The terminal device of claim 11, wherein the entering condition and the exiting condition are based on a first L1-RSRP of a serving beam and a second L1-RSRP of a target beam.

13. The terminal device of claim 12, wherein the entering condition comprises that the first L1-RSRP is smaller than the second L1-RSRP plus a first threshold, and the exiting condition comprises that the second L1-RSRP is greater than the first L1-RSRP plus a second threshold.

14. The terminal device of claim 11, wherein the entering condition and the exiting condition are based on an event threshold.

15. The terminal device of claim 11, wherein the entering condition and the exiting condition are predefined or configured by a network device.

16. A network device comprising:
at least one processor; and
at least one memory storing instructions that, when executed by the at least one processor, cause the network device at least to:
transmit, to a terminal device a configuration for a filtering parameter for user equipment initiated beam management (UEIBM);
receive, from the terminal device information of the UEIBM based on the configuration; and
perform the UEIBM based on the information of the UEIBM.

17. The network device of claim 16, wherein the filtering parameter is a number of measurement instances for the UEIBM.

18. The network device of claim 16, wherein the filtering parameter is a time window for determining a number of measurement instances for the UEIBM.

19. The network device of claim 16, wherein the configuration comprises a value of the filtering parameter for the UEIBM.

20. A method comprising:
receiving, from a network device a configuration for a filtering parameter for user equipment initiated beam management (UEIBM);
determining an event for triggering the UEIBM based on the filtering parameter for the UEIBM; and
transmitting, to the network device information of the UEIBM based on the event.
